(19) United States
(12) Patent Application Publication
(10) Pub. No.: US 2010/0043267 A1
(43) Pub. Date: Feb. 25, 2010

(54) LABEL INFORMATION REDACTOR

(76) Inventor: Justin H. Sterling, Amherst, NY (US)

Correspondence Address: BUCHANAN INGERSOLL & ROONEY PC, P.O. BOX 1404, ALEXANDRIA, VA, 22313-1404, US

(21) Appl. No.: 12/546,567

(22) Filed: Aug. 24, 2009

Related U.S. Application Data
(60) Provisional application No. 61/090,918, filed on Aug. 22, 2008.

(51) Int. Cl. G09F 3/10; B32B 38/18

(52) U.S. Cl. 40/638; 156/584

(57) ABSTRACT

Embodiments of the invention relate to a sensitive information redactor including a frame and means for removing at least part of the frame and at least part of a label. This results in sensitive information on a label to become illegible or removed for separate disposal or retention.

This application claims priority to pending U.S. Provisional Patent Application No. 61/090,918, filed on Aug. 22, 2008, and incorporated by reference herein.

### BACKGROUND OF THE INVENTION

1. Field of the Invention

Embodiments of the invention related to components, devices, mechanisms, systems and methods for redacting and, optionally, disposing or retaining label information, including for example sensitive information, that is present on a label.

2. Description of the Related Art

Identity theft is an increasingly prevalent and serious threat throughout the world impacting 8-10 million Americans annually and causing yearly losses of approximately $50 billion to businesses. Identity theft can be perpetrated by unauthorized or incidental access to information, particularly sensitive information, and is most commonly gained through low tech methods. One area where sensitive information is increasingly being generated, stored, and used is the health care industry.

Regulations introduced under the Privacy Rule of the U.S. Health Insurance Portability and Accountability Act (“HIPAA”) have created requirements regarding the handling and exposure of Protected Health Information (PHI) by covered entities making violations punishable by law creating new criminal and civil liabilities within the health care industry. Under the Privacy Rule covered entities must implement reasonable safeguards to protect the privacy of PHI. This includes avoiding prohibited and limiting incidental disclosures and uses of PHI, in any form, including in connection with the disposal of such information making places accessible by the public or unauthorized persons off limits for disposal. Failure to implement reasonable safeguards to protect PHI in connection with disposal could result in impermissible disclosure of PHI and civil and criminal consequences.

One area where sensitive and protected health information continues to be readily accessible are prescription labels. The number of prescriptions being filled in the United States was expected to increase from 3.5 billion in 2008 to over 4.1 billion in 2010. This is a growth rate of over 17%, and it promises a similar increase in opportunities for identity theft. With the oldest of the Baby Boomer Generation (those born between 1946 and 1964) now turning 63 years old and making up approximately 45% of the U.S. population, the volume of sensitive and protected health information is likely to increase in the coming years. This will increase the importance of establishing ways to secure PHI from the public domain.

In addition to rising prescription sales, prescription drug abuse among teens and young adults is now an epidemic. This furthers the risks of having prescription label information still accessible during disposal, because a typical prescription label contains all the information required to fill- and pick-up a prescription at even the largest pharmacies. This may be the case even if the person filling and/or picking up the prescription is not the patient or the person designated by the patient to fill and/or pick up the prescription. Teens, young adults and others that seek out prescription drugs may find the trash an easy target for accessing information needed to fill- and pick-up a prescription as teens and young adults typically walk or ride bikes places. This could present serious risks to both a pharmacy and/or the residence thought to have a particular prescription. Currently many people throw away old prescription bottles with the label still legible as there is not an effective, safe or self-contained means for redacting sensitive information on a label prior to disposal.

A number of patents and published applications discussed labels. These include, for example, U.S. Pat. Nos. 3,835,564; 4,277,089; 4,318,235; 4,619,858; 5,056,827; 5,263,743; 5,895,075; and 7,140,135, and U.S. Patent Publication Nos. 2003/0012911 A1; 2003/0061750 A1; and 2003/0158025, all of which are incorporated by reference herein. Unfortunately, all of the solutions proposed by those documents have been unsatisfactory for one or more reasons.

Redacting sensitive information from a label is also desirable in situations other than those related to health care distribution. For example, an individual may wish to redact sensitive information on a mailing label, a newspaper, magazine, or other periodical. An individual may also wish to have a self-contained way to remove a price tag or other identifying information placed on a consumer good.

### BRIEF SUMMARY OF THE INVENTION

Embodiments of the invention provide systems and devices for redacting a label by destroying or removing information on a label for proper disposal or retention. Utilization related to sensitive information is focused upon herein.

Embodiments of the invention may have one or more components, surface types and systems. In one embodiment the sensitive information redactor is a continuous frame. In another embodiment the sensitive information redactor comprises a frame and an adjoining tear-away device. In a further embodiment the sensitive information redactor comprises a frame, adjoining tear-away device and tear-away device release mechanism.

Embodiments of the invention may have one or more properties. For example, the components may be thin, may be light, may be colored, may contain an adhesive and in some cases more than one type, may incorporate one or more construction materials, have one or more ply, contain perforations, have one or more devices or mechanisms, have one or more systems, require one or more steps to effectuate the desired result of redacting information, contain notices on the components, and they may be compliant with a number of regulations for size and adhesiveness.

The invention may be designed as a separate product or incorporated into a label design to form a new label providing a self-contained and effective means for redacting information contained on a label.

In a simple form the sensitive information redactor comprises a frame in which a label is placed over top in a certain fashion. In one embodiment, the label is placed partly over the frame leaving an area of the frame to function as the tear-away device. In another embodiment the frame is covered completely by the label and only a portion of the tear-away device release mechanism is exposed. In one embodiment the frame does not have adhesive on the bottom but is shaped in a manner that when conjoined with a label the adhesive remaining exposed on the label is sufficient for affixing both to an object. In another embodiment the frame has an adhesive bottom for affixing to the object and a top for conjoining with the label. The frame may contain adhesive and may contain more than one type of adhesive. The adhesive used on a frame may be the same or different from that of the label. The invention may be designed for redacting a predetermined part of a label or removing a label entirely. The redacting of sensitive information may result in the removal of a label entirely, but occur incrementally.

The tear-away device of the sensitive information redactor may be a continuous component of the frame or adjoined to the frame. In one embodiment the tear-away device is a tab. As with the frame, the tear-away device may have adhesive and may have more than one adhesive to adhere the tear-away device to the object and/or opposite top side of a label (should overlap occur) prior to engagement. In one embodiment the tear-away device does not have adhesive on the bottom. In another embodiment the tear-away device has an adhesive bottom for affixing to the object and/or opposite top side of a label (should overlap occur).

A tear-away device release mechanism may be adjoined to the tear-away device and frame to limit the potential of accidental or premature removal by creating a two-step system of removal. The tear-away device release mechanism requires engagement and deployment to be able to access the tear-away device to then redact the label. In one embodiment, the tear-away device release mechanism is adjoined with the tear-away device by a perforated edge and comprises an adhesive side for affixing to the object and/or opposite top side of a label (should overlap occur) prior to engagement and deployment. The tear-away device release mechanism may contain adhesive and may contain more than one type of adhesive. The tear-away device release mechanism may have a designated area for engagement of the tear-away device release mechanism such as a tab, which may also contain adhesive. In one embodiment, the tear-away device release mechanism contains adhesive for initial attachment to the object and/or opposite top side of a label (should overlap occur) prior to engagement and a perforated edge for initial adjoinment with the tear-away device concealing it prior to removal of the tear-away release mechanism. Adhesives used for the tear-away tab release mechanism may be the same or different from that used for the tear-away device, frame and/or label.

The components of the sensitive information redactor may be of the same or different material as the sensitive information redactor and/or label. The components may be transparent, translucent, opaque or a combination of one or more and may be colored to make certain elements more apparent.

The sensitive information redactor components may vary size and surface area to effectuate a desired result. In one embodiment a tear-away device is large in size to enable users that may have difficulties with small objects a greater surface area to effectuate the desired result. As noted above, those skilled in the art will recognize other shapes or configurations that are possible, including but not limited to a tag, flap, stub, or strip. The tear-away device may be any geometric or irregular shape so long as the shape is adequate to allow the device to be used. Further, the surface area may vary to maximize efficiency of materials used in production while maintaining performance and function of the invention. For example, in one embodiment a small triangle frame is used to reduce accuracy needed for application and materials needed for construction. In another embodiment a large trapezoid frame is used. As noted above, those skilled in the art will recognize other shapes or configurations that are possible to effectuate the desired result. In a further embodiment the frame of the sensitive information redactor has open areas for reducing the material used in production and product along with the weight of the product while still redacting at least the area of sensitive information on the label upon removal.

The sensitive information redactor may be comprised of one or more plys. A two-ply design may provide a cleaner removal result when redacting information from a label should the intention be to reaffix the label to a sheet for record keeping or maintain the integrity of the object. The bottom-ply of a two-ply sensitive information redactor would remain on the object rather than create the potential of removing or tearing the object as a result of the adhesive conjoining the sensitive information redactor and object as in the example of a cardboard container or newspaper. Plys may also be referred to as layers, sheets, or strata.

The sensitive information redactor may be designed to involve one or more steps to effectuate the desired result. In certain embodiments the number of plys of the sensitive information redactor corresponds to the number of steps useful for removal. In one embodiment the tear-away device and tear-away device release mechanism are conjoined by an adhesive to form a two-ply and two-step redacting process wherein the adhesive of the bottom-ply is different to that conjoining the tear-away device and tear-away device release mechanisms to enable the bottom-ply to remain fastened to the object and/or label (should overlap occur) while the tear-away device releases to enable redacting of the label. In another embodiment the tear-away device and tear-away device release mechanism are conjoined by a perforated edge with the tear-away device release mechanism having a device to tear along the perforated edge for releasing and exposing the tear-away device to enable removal of the tear-away device to redact the sensitive information whereby forming a two-step redacting process. Additional steps for engagement and removal of the sensitive information redactor may give added assurance that the label maintain the manner in which it is intended to remain fastened to the container until intentionally engaged.

The components of the sensitive information redactor may be designed with information or with the intent of information being applied directly to the sensitive information redactor. In one embodiment of the invention, a system is provided whereby sensitive information is printed on a sensitive information redactor of the invention. The sensitive information redactor combination is distributed on a prescription container. Upon exhaustion or expiration of the medication, or at any other chosen time, any remaining contents may be discarded and the sensitive information redactor system may be employed to redact information from a label by directly making it illegible or separating the information to properly secure or destroy it prior to disposal, and the object disposed of separately. Alternatively, the sensitive information redactor may be retained with the label intact and/or legible to be maintained as a record. In another embodiment, the sensitive information redactor shreds the label during removal making the sensitive information no longer legible.

Embodiments of the invention may have one or more properties. For example, the components may be thin, may be light, may be colored, may contain an adhesive and in some cases more than one type, may incorporate one or more construction materials, have one or more ply, contain perforations, have one or more mechanisms, require one or more steps to effectuate the desired result or contain notices, and they may be compliant with a number of regulations for size and adhesiveness.

Embodiments of the invention may be adapted for use upon any container, object, or surface upon which application of and subsequent removal of a label is desired.

The sensitive information redactor may be easily affixed to an object. An object may be, for example, but is not limited to a prescription container. A prescription container may be, but is not limited to, a bottle, box, tube, packet or blister pack and may vary in construction material including, but not limited to, plastic, cardboard, paper, metal, foil or glass. Unless specifically stated, the identity of the entity applying or removing the sensitive information redactor is not material. For example, the entity may be a patient, a pharmacist, a pharmacist's assistant, a patient's assistant, a patient's family member, doctor, health care provider, a business, a hospital, a non-profit organization, or a machine.

### DETAILED DESCRIPTION OF THE SEVERAL VIEWS OF THE DRAWINGS

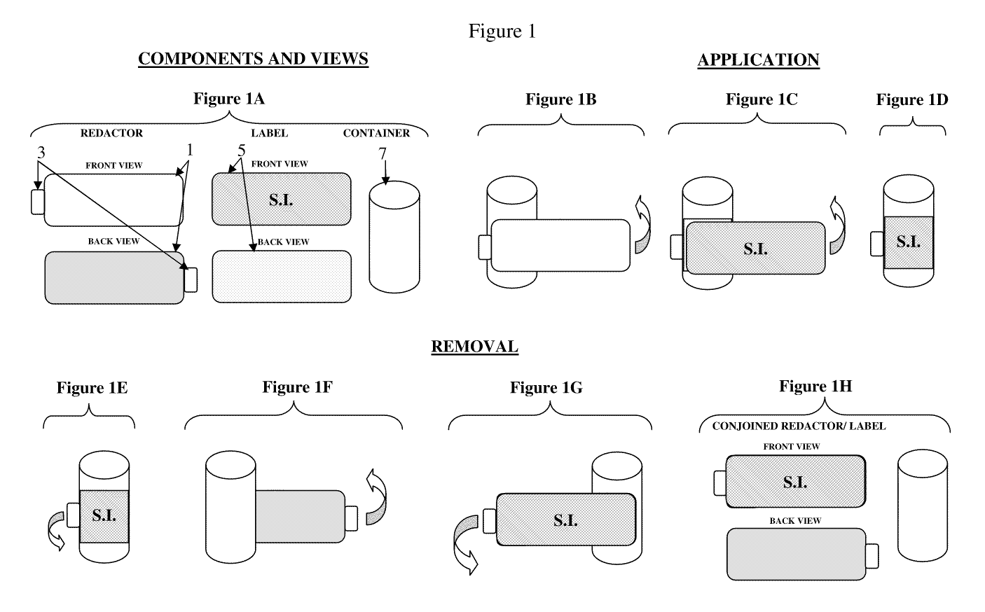

FIG. 1, including FIGS. 1A through 1H, shows a sensitive information redactor design with a large frame with an adjoining transparent tear-away device shown as a tab.

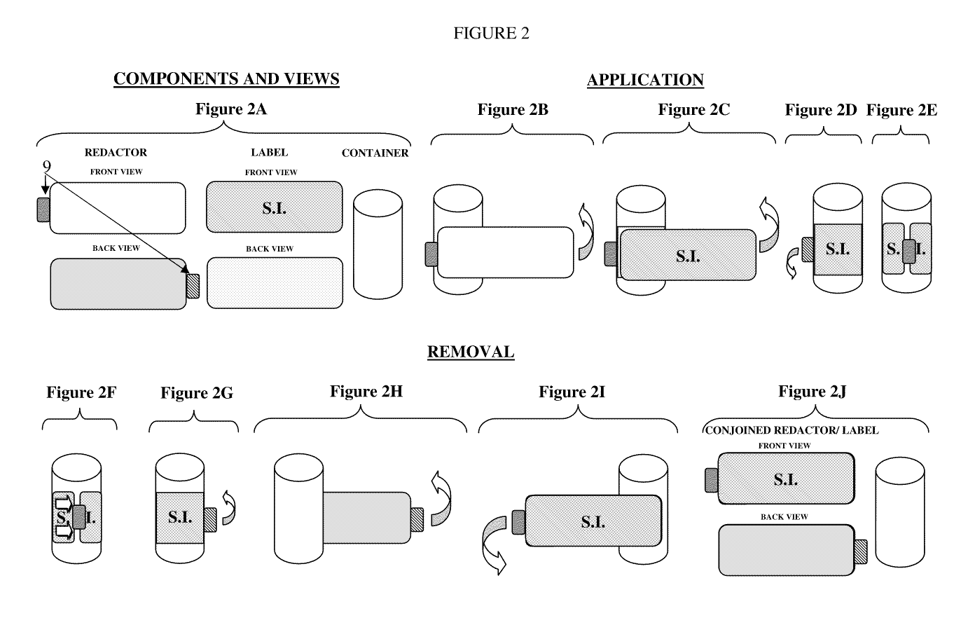

FIG. 2, including FIGS. 2A through 2J, shows a sensitive information redactor design with a large frame having a colored tear-away device with an adhesive underside. This allows the tear-away device to be initially fastened to the object and/or label (if overlap occurs).

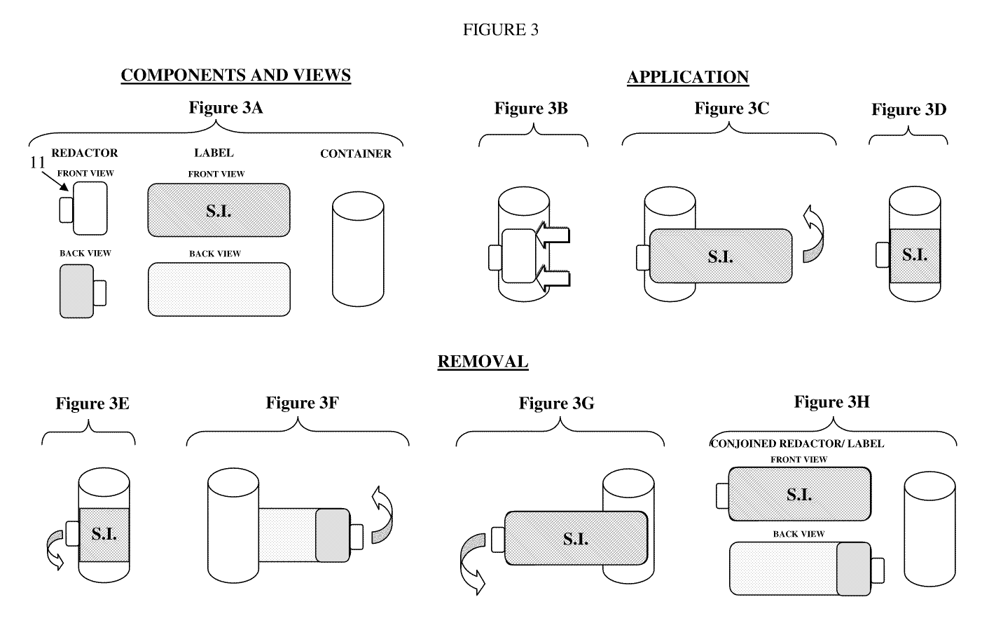

FIG. 3, including FIGS. 3A through 3H, shows a sensitive information redactor design with a small frame.

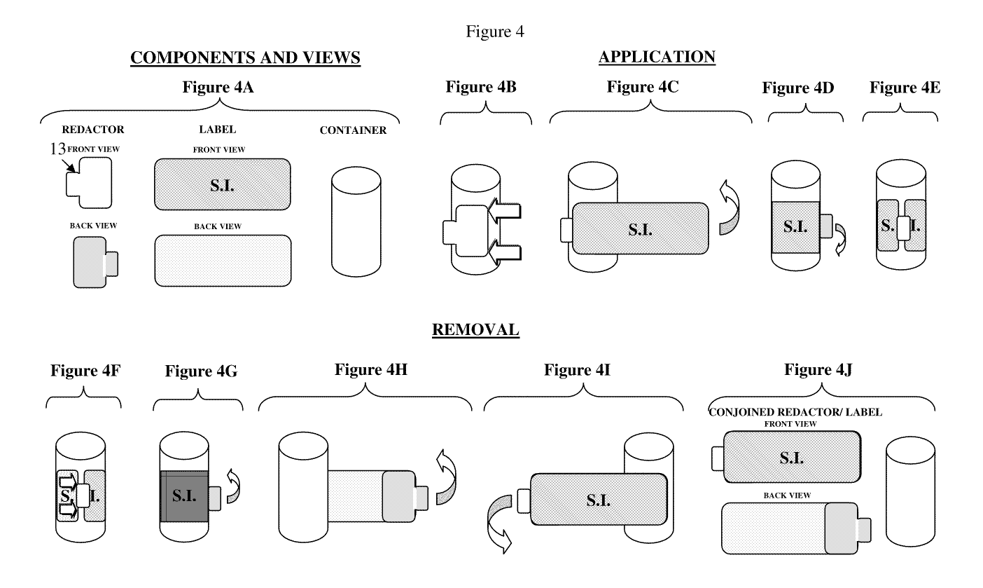

FIG. 4, including FIGS. 4A through 4J, shows a sensitive information redactor design with a continuous small frame. The frame has a transparent tear-away device tab having adhesive on the underside.

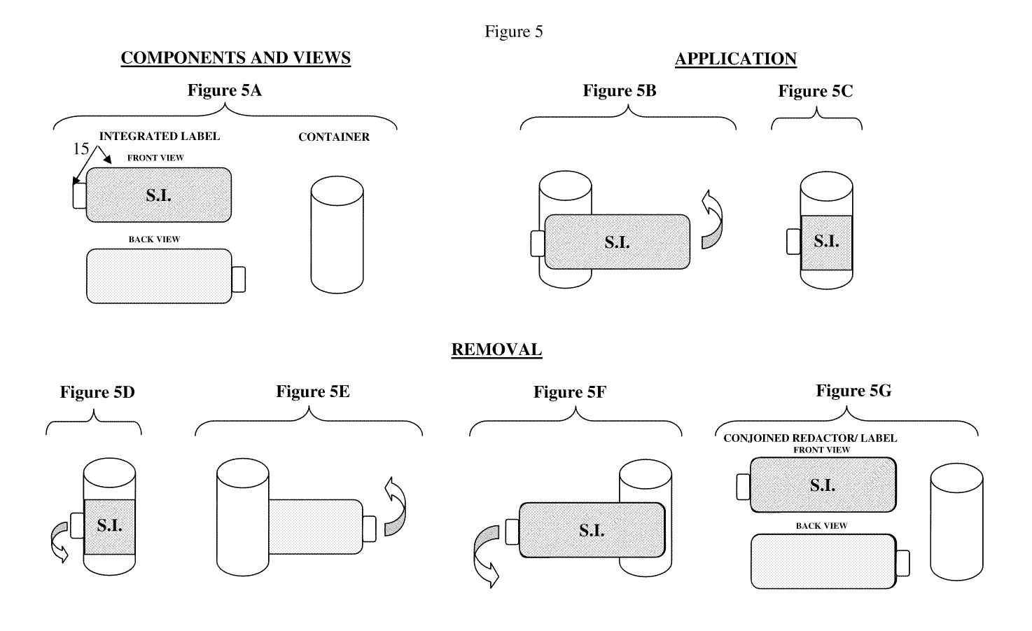

FIG. 5, including FIGS. 5A through 5G, shows a consolidated label and sensitive information redactor product.

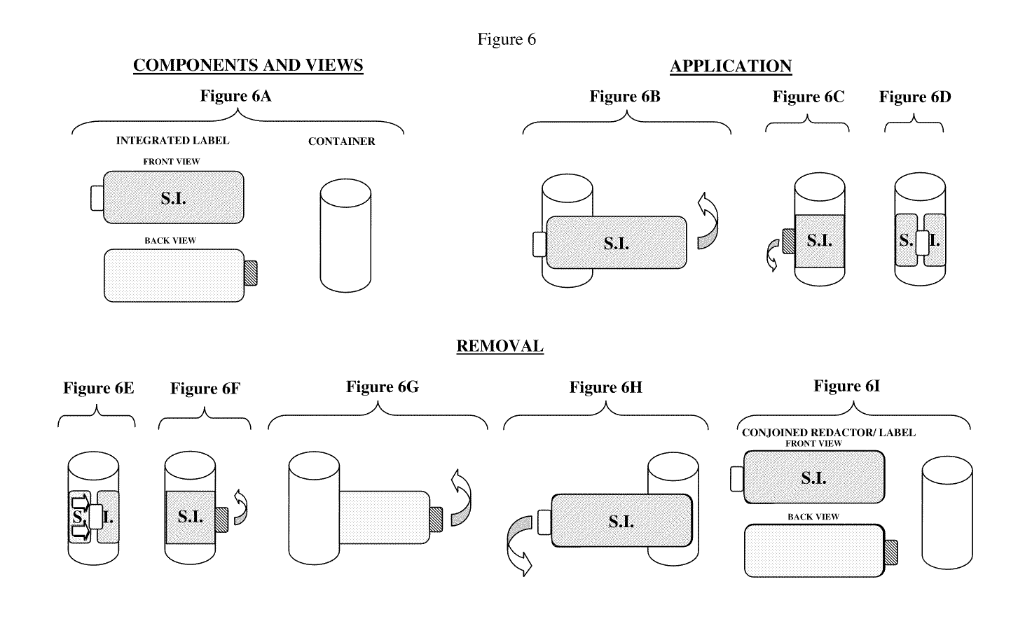

FIG. 6, including FIGS. 6A through 6I, shows a consolidated label and sensitive information redactor product with adhesive on the underside of the tear-away device.

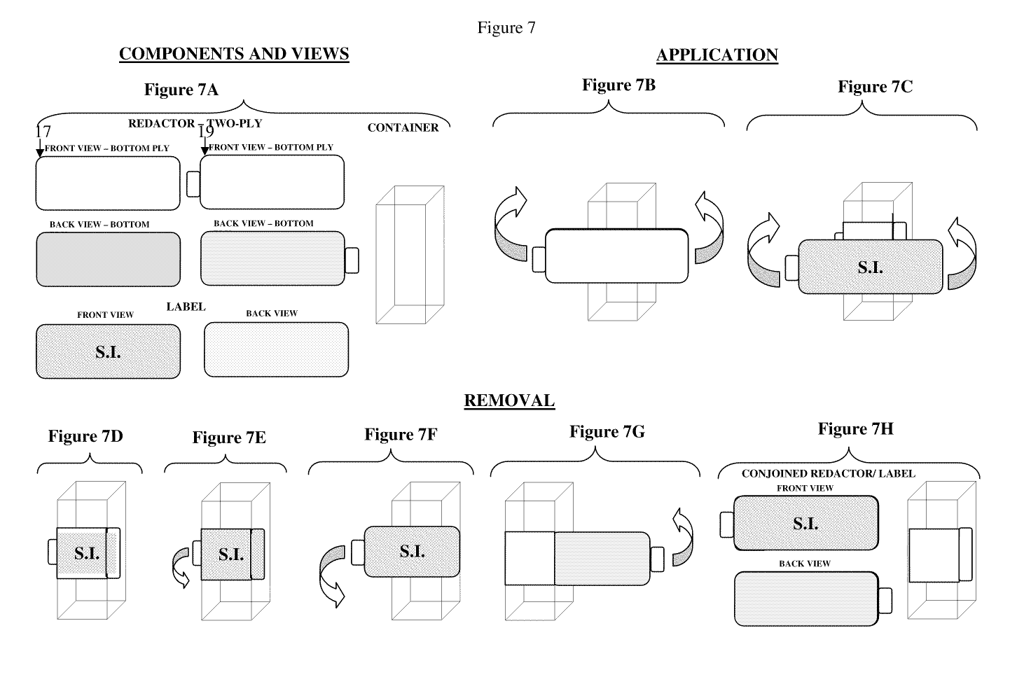

FIG. 7, including FIGS. 7A through 7H, shows a sensitive information redactor design with a two-ply large frame applied to a cardboard box container. A two-ply sensitive information redactor design may offer cleaner removal from objects made of certain materials like cardboard or paper.

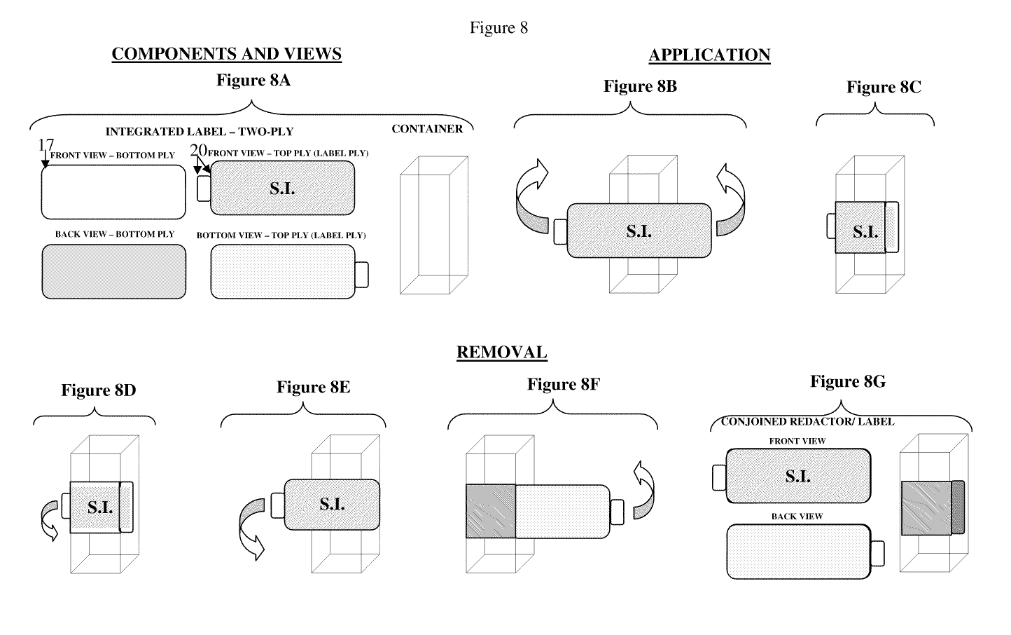

FIG. 8, including FIGS. 8A through 8G, shows a two-ply consolidated sensitive information redactor label. A two-ply consolidated sensitive information redactor label design may offer cleaner removal from objects made of certain materials like cardboard or paper.

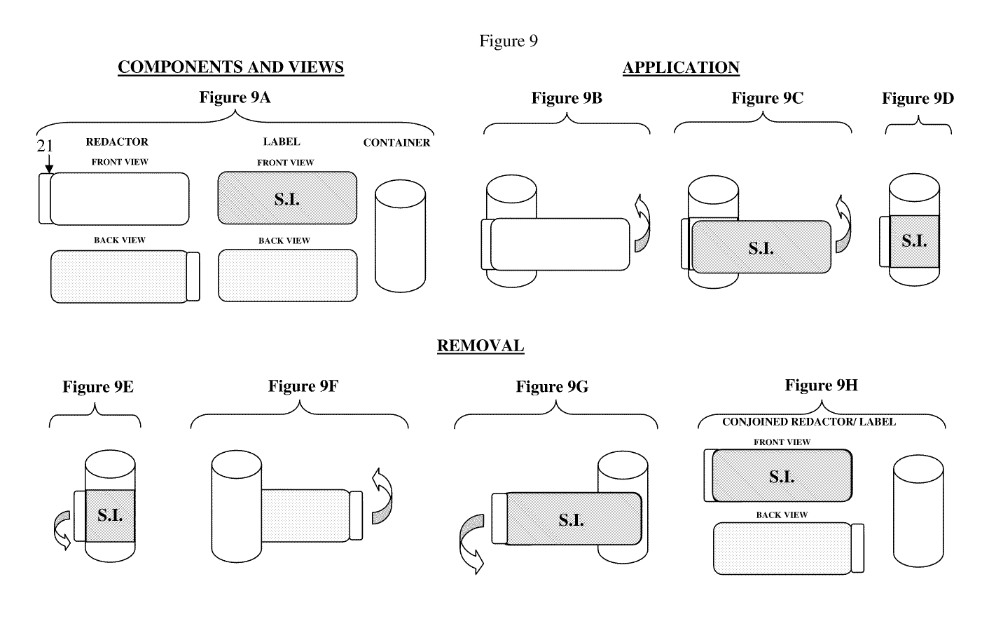

FIG. 9, including FIGS. 9A through 9H, shows a sensitive information redactor design with a large frame having a large adjoining tear-away device.

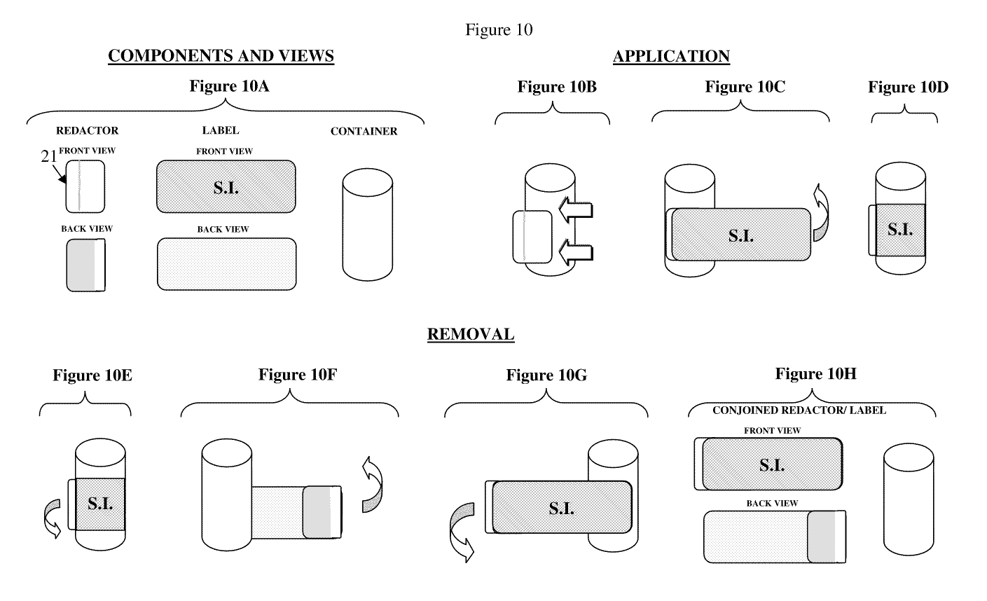

FIG. 10, including FIGS. 10A through 10H, shows a sensitive information redactor design with a continuous small frame containing an area absent of adhesive whereby forming a means to redact the sensitive information.

FIG. 11, including FIGS. 11A through 11G, shows a consolidated sensitive information redactor label with a large tear-away device area having a different adhesive than the consolidated sensitive information redactor. This forms the tear-away device when engaged.

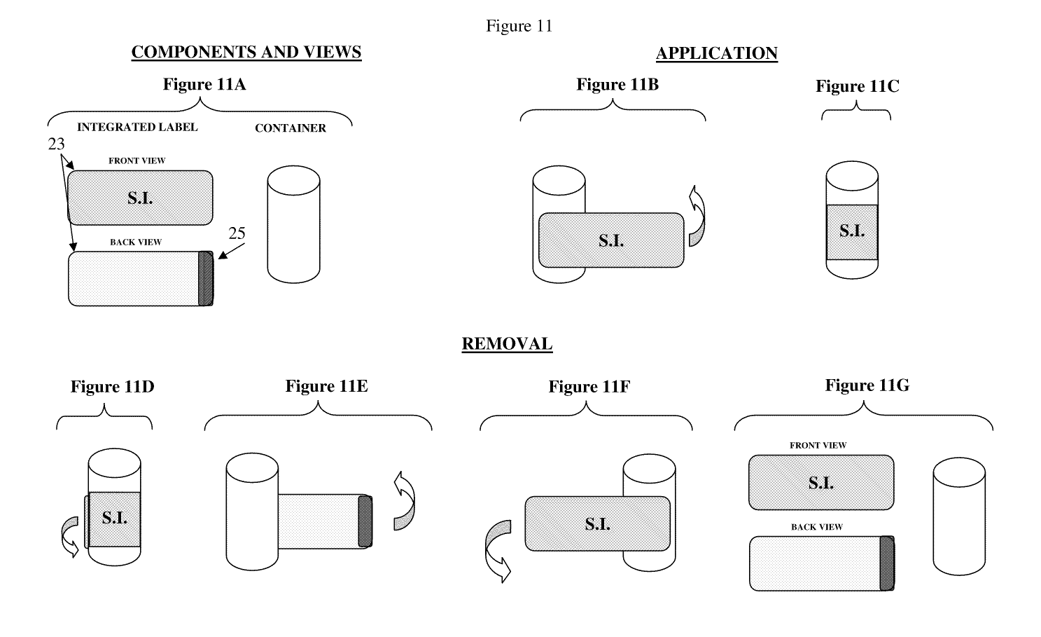

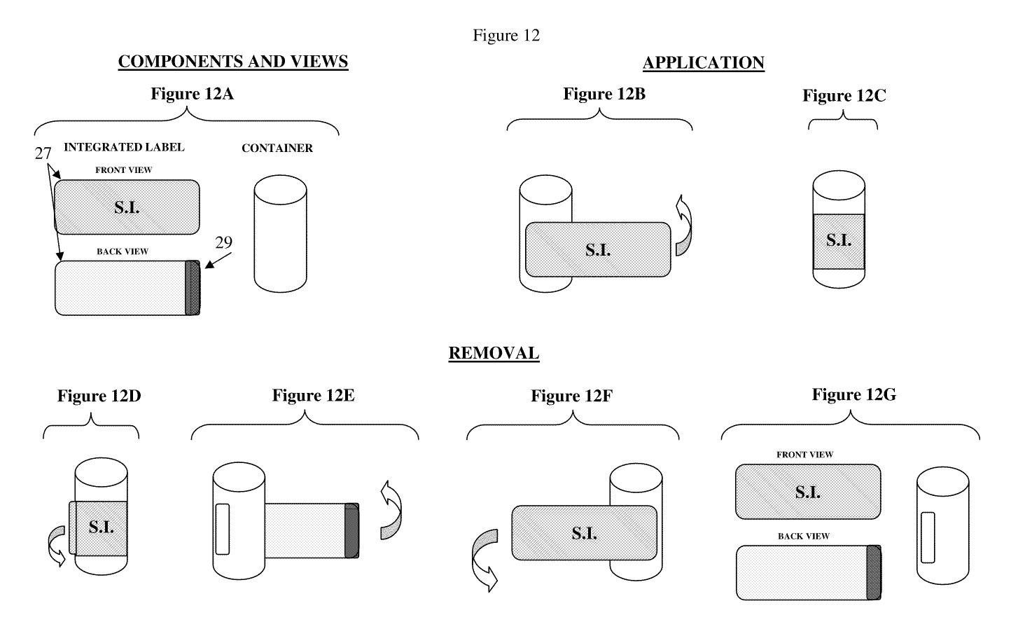

FIG. 12, including FIGS. 12A through 12G, shows a consolidated sensitive information label with a large two-ply tear-away device area with the bottom-ply having the same adhesive as the label and the top-ply a different adhesive conjoining with the second-ply to allow the bottom-ply to break away from the top-ply and remain on the object.

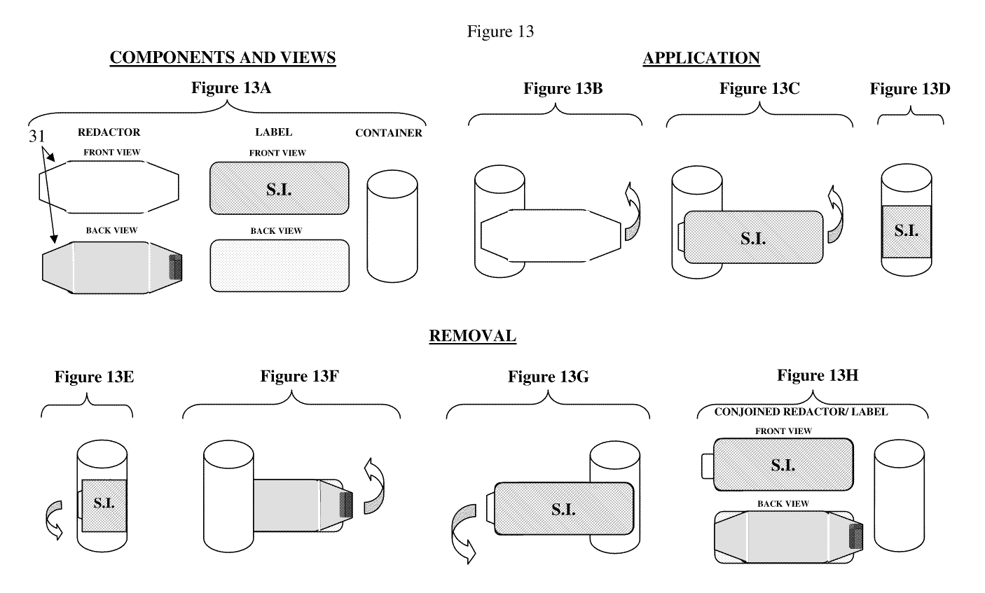

FIG. 13, including FIGS. 13A through 13H, shows a sensitive information redactor design with a large frame using the shape of a trapezoid. This design example enables the use of less construction material to effectuate a similar result.

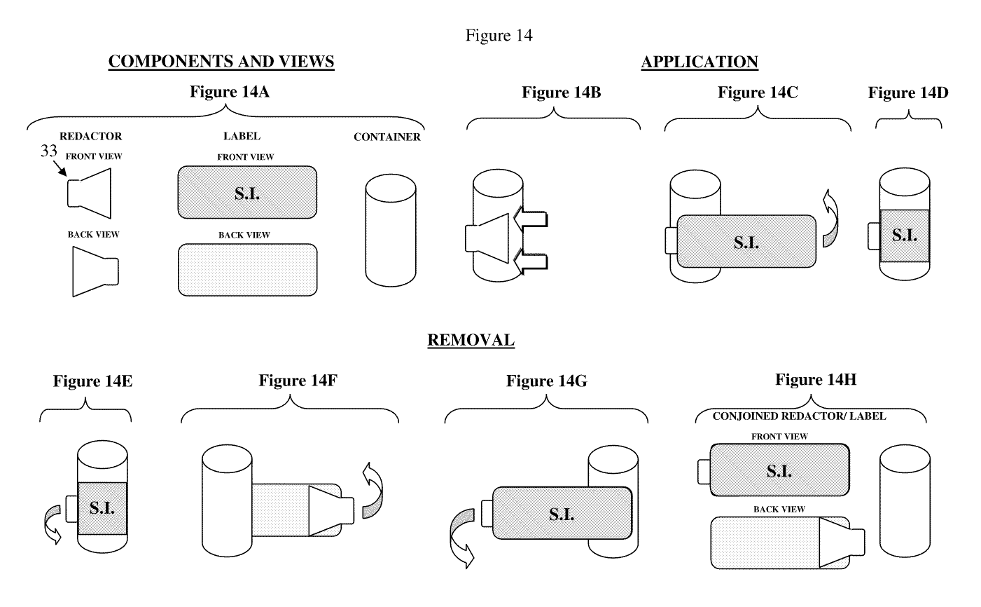

FIG. 14, including FIGS. 14A through 14H, shows a sensitive information redactor design with a continuous small frame using less construction material than frames of other embodiments.

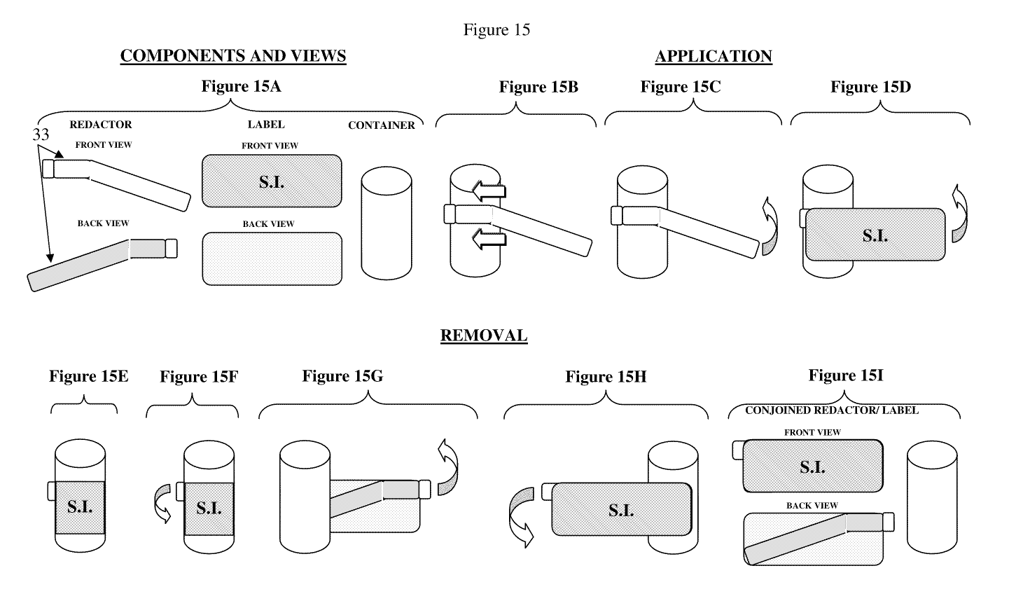

FIG. 15, including FIGS. 15A through 15I, shows a sensitive information redactor design with a frame using less construction material than other embodiments while enabling removal of a label entirely.

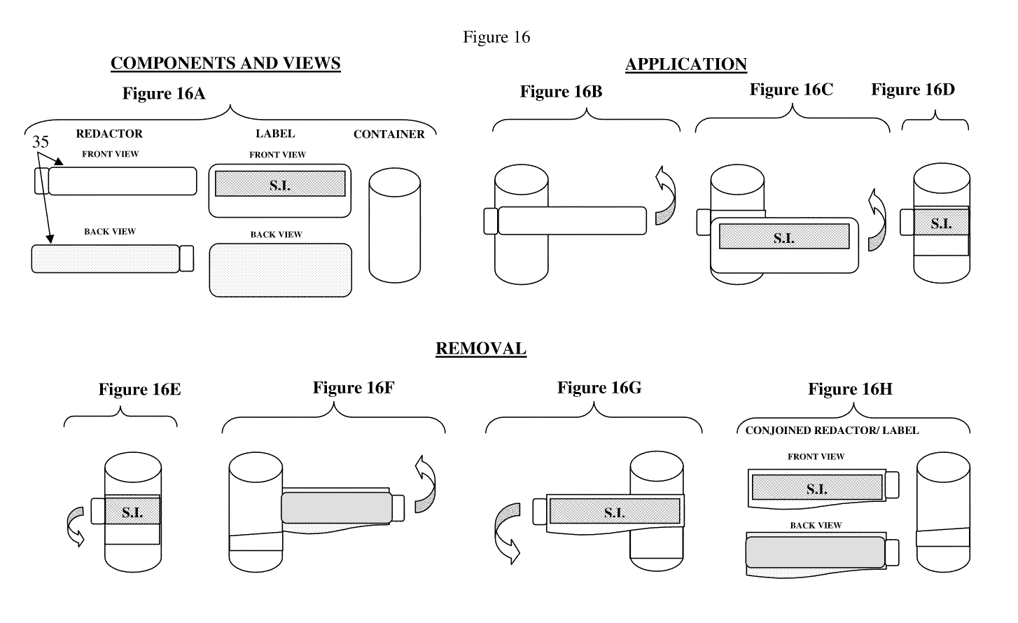

FIG. 16, including FIGS. 16A through 16H, shows a sensitive information redactor design with a frame that extends the length and width of the sensitive information.

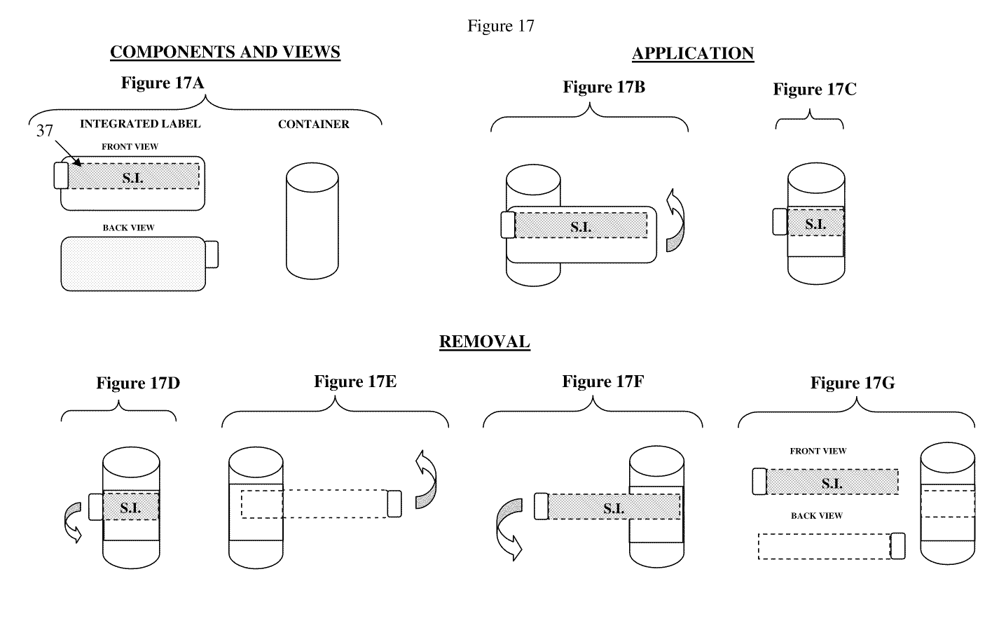

FIG. 17, including FIGS. 17A through 17G, shows a consolidated sensitive information redactor label design comprising of perforated edges around a targeted area that contains sensitive information.

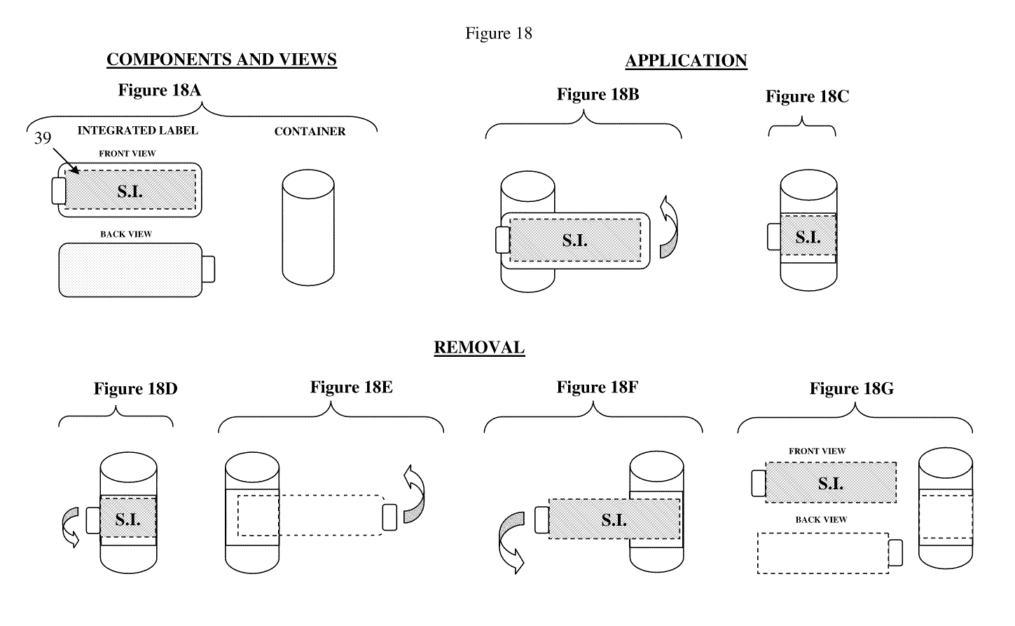

FIG. 18, including FIGS. 18A through 18G, shows a consolidated sensitive information redactor label design comprised of perforated edges around a large area to ensure broad removal of information.

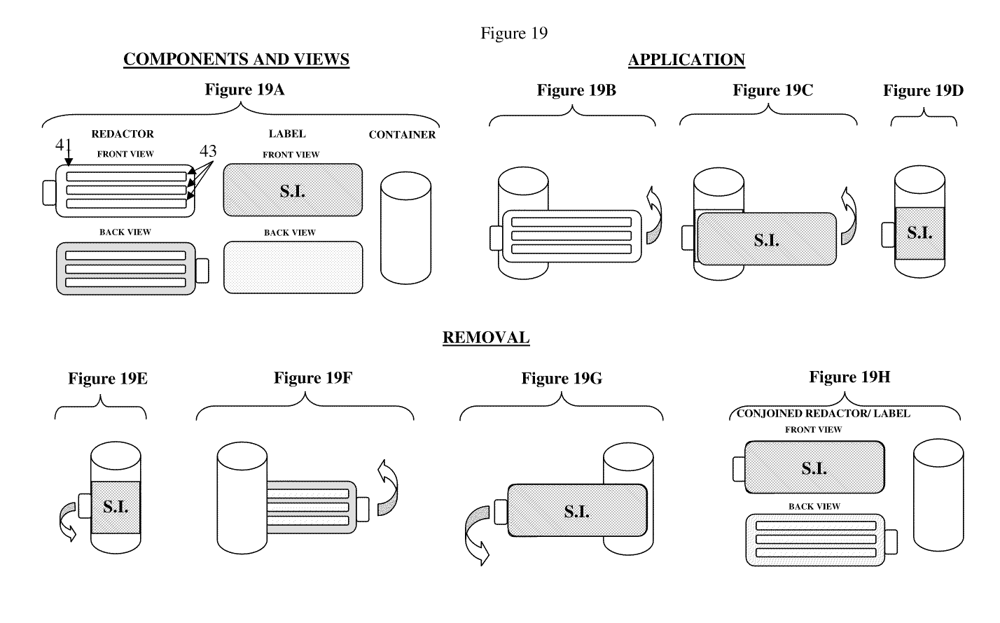

FIG. 19, including FIGS. 19A through 19H, shows a sensitive information redactor design with a large frame having open areas within the frame.

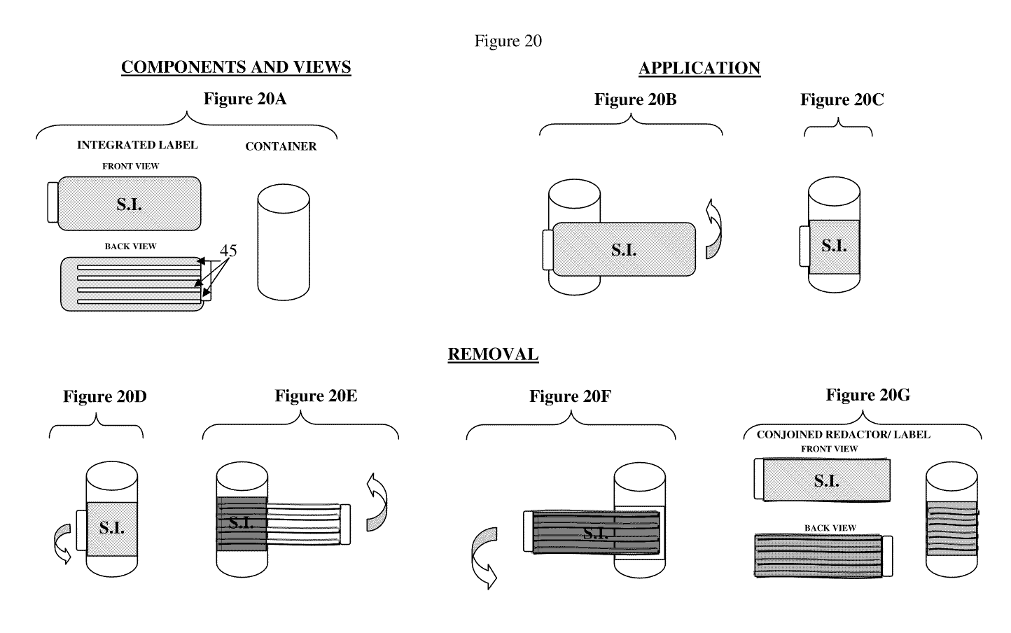

FIG. 20, including FIGS. 20A through 20G, shows a sensitive information redactor design with a frame constructed to shred/destroy areas of a label containing sensitive information. Reinforcement material may be used in the construction of the frame, such as fiberglass, to reinforce areas of the sensitive information redactor being stressed during removal

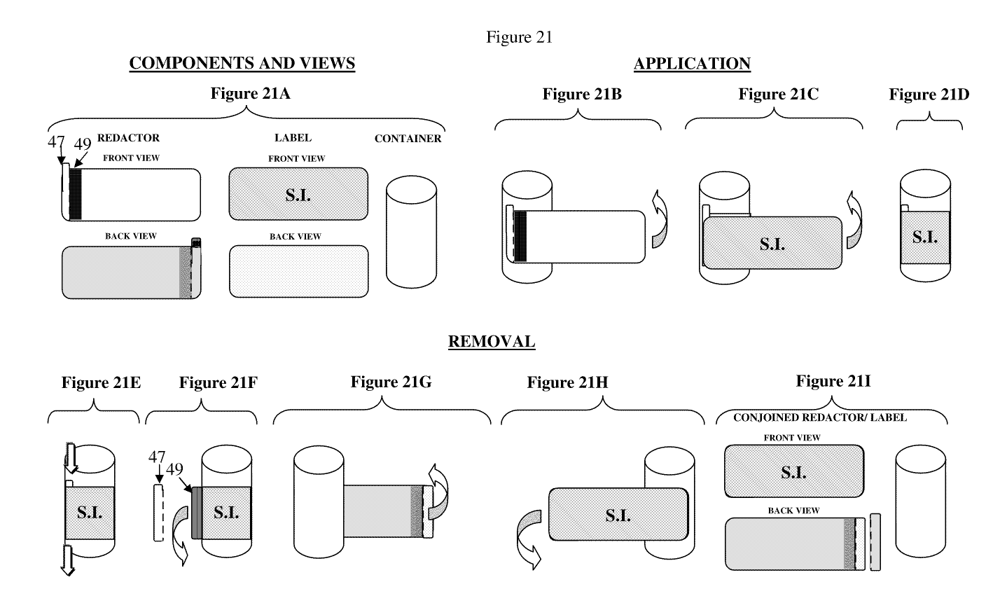

FIG. 21, including FIGS. 21A through 21I, shows a two-step sensitive information redactor design with a large frame, tear-away tab device and tear-away device release mechanism. In this design the sensitive information redactor is initially covered by the label and the tear-away device release mechanism is initially adjoined to the tear-away device by a perforated edge. Engagement of the tear-away device release mechanism along the perforated edge exposes the tear-away device used in redacting sensitive information.

FIG. 22, including FIGS. 22A through 22G, shows a two-step sensitive information redactor design with a large frame, tear-away tab device and tear-away device release mechanism. In this design the sensitive information redactor frame is covered by the label and the tear-away device release mechanism extends beyond the label and is initially affixed to the container. The tear-away device and tear-away device release mechanism are adjoined by a perforated edge. Engagement of the tear-away device release mechanism along the perforated edge releases the tear-away device for use in redacting the sensitive information.

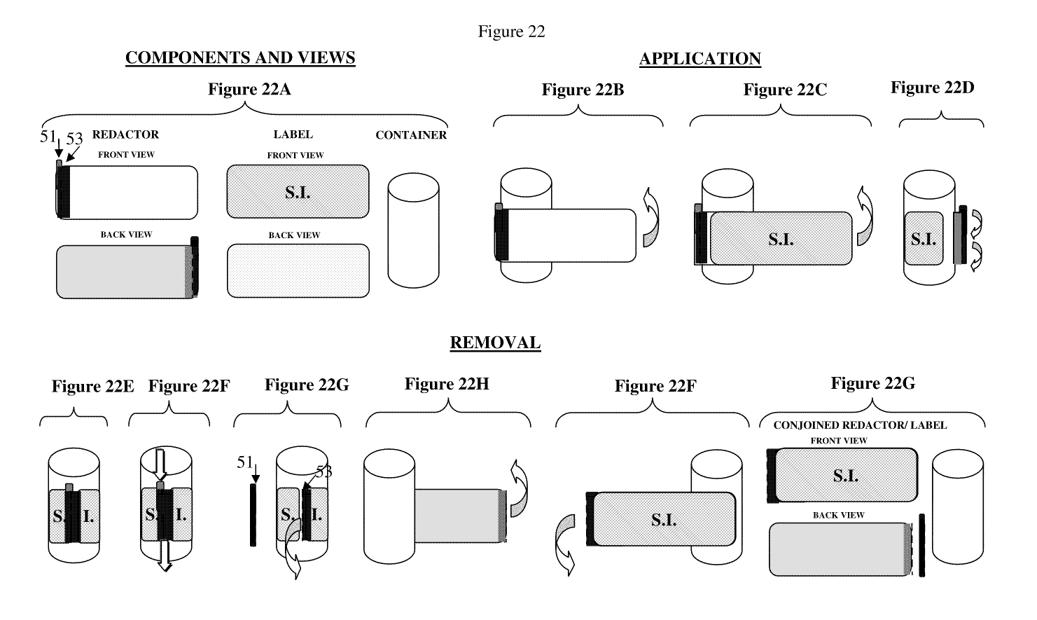

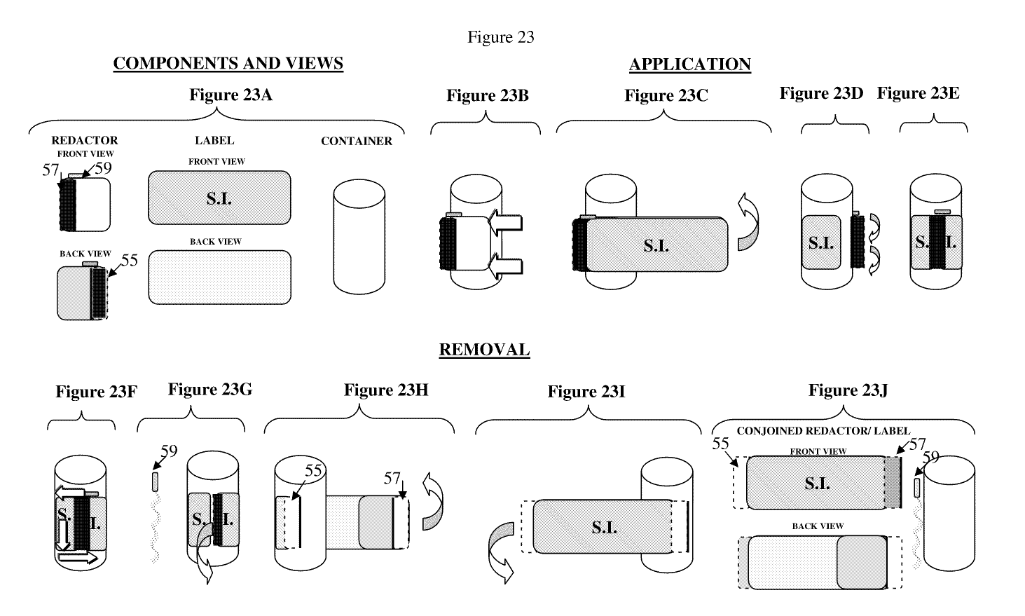

FIG. 23, including FIGS. 23A through 23J, shows a two-step sensitive information redactor design with a small frame having a two-ply conjoined tear-away device and tear-away device release mechanism. The frame/tear-away device and tear-away device release mechanism are conjoined by three sides of perforated edges. The tear-away device release mechanism comprises a device used for separating the perforated edges to release the tear-away device used in removing the sensitive information whereby creating a two-step removal process.

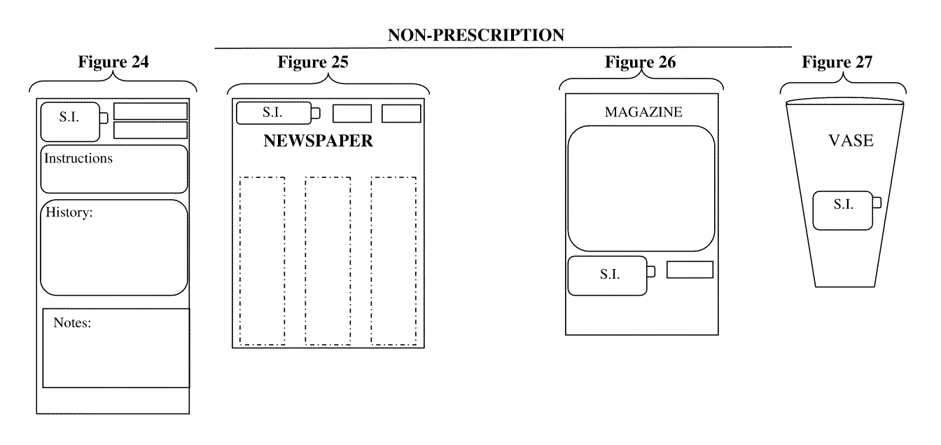

FIG. 24 shows an embodiment of the invention incorporated into a printable page.

FIG. 25 shows an embodiment of the invention provided on a newspaper.

FIG. 26 shows an embodiment of the invention used in conjunction with a magazine.

FIG. 27 shows an embodiment of the invention applied to a consumer end-product.

### DETAILED DESCRIPTION OF THE INVENTION

Preferred embodiments of components, devices, mechanisms, systems and methods for redacting information are now discussed with respect to the several designs and views of the figures. It should be noted that the figures and the descriptions are exemplary only, and that one skilled in the art will recognize that a number of properties depicted in the figures may vary, be used interchangeably, be preferred or optional when creating a sensitive information redactor product and that the scope of the invention should only be limited by the claims.

For example, although the tear-away device as shown in the figures is configured for the convenience of a right-handed user, one skilled in the art could, within the claims, configure the tear-away device relative to the label to provide convenience for a left-handed user by moving the location of the tear-away device to a different location. It should be noted that the figures are not drawn to scale. It should also be noted that although the figures and description may reference “sensitive information” (or its abbreviation, “S.I.” or “SI”), embodiments as related herein may be suitable for any information, sensitive, confidential, protected or not, that is placed on a label that may later be removed. Sensitive information may include, for example, but is not limited to one or more of name, address, phone number, date of birth, Social Security number, height, weight, eye color, hair color, picture, health information (e.g. prescription name, prescription type, prescription Rx number, dose, quantity, refills, dates, prescribing doctor, business name, business address, business phone number, price, bar code, method of payment) or any other information that an individual or entity may consider sensitive or that can be used to deduce information, perhaps as a result of the location it is being discarded. It should further be understood that when the sensitive information redactor is discussed as having been removed, this also results in removal of the frame as discussed below.

FIG. 1, including FIGS. 1A through 1H, shows a sensitive information redactor design with a large frame 1 comprising one side adhesive and one side for conjoining with a label 5 and an adjoining transparent tear-away device 3 to maximize visibility of the label and/or contents of an object 7. This embodiment is preferred for a container or other end-product in which the label bearing the sensitive information is not likely to be released as a whole because of size and adhesiveness. Of course, it should not be construed to be limited to this use.

The object may be, for example, but is not limited to a prescription container bottle or prescription bottle. Those skilled in the art will recognize that adhesives currently in use in the healthcare labeling industry will also be suitable for application in embodiments of the invention.

FIG. 1B shows the fastening of the adhesive side of the frame to the container. FIG. 1C shows the fastening of the adhesive side of the label over the top of the frame and onto the container. FIG. 1D shows a completed product, including a sensitive information redactor and label affixed on the object.

The removal of the sensitive information redactor and label through the use of force to the tear-away device is illustrated in FIGS. 1E through 1G. The final, removed and conjoined sensitive information redactor and label is shown in FIG. 1H. It should be noted that as with other designs herein, in an alternate application process the sensitive information redactor may first be conjoined with the label and then affixed to the container. Although the tear-away device shown in this and other embodiments is a tab, it could take other forms.

FIG. 2, including FIGS. 2A through 2J, shows a sensitive information redactor design similar to the construction of that shown in FIG. 1, but having a tear-away device 9 that is translucent, making it easier for users to see while maintaining the ability to see through the tear-away device as not to impede the ability to read information or see contents of the object. The back side of the tear-away device has adhesive for fastening to the container and/or label (should overlap occur) until removal.

The application of the sensitive information redactor as shown in FIGS. 2B through 2D is similar to that of FIG. 1 with the only difference being that the adhesive side of the tear away device is affixed to the container as shown in FIG. 2E. Removal of the sensitive information redactor, as shown in FIGS. 2F through 2I, is also similar to FIG. 1 but with the initial step requiring the disengagement of the tear-away device from the container as shown in FIG. 2F.

One or more types of adhesive may be used for this design as it may be preferred that one type of adhesive is used for the frame and a different adhesive is used for the tear-away device. It should also be noted that the tear-away device should be thought of throughout as able to be transparent, translucent or opaque and with or without color whether shown as a separate design or not. Further, the tear-away device may also contain an adhesive in designs where it is not shown as a separate design. This and other embodiments may be used interchangeably throughout the designs even though not shown as a separate design.

FIG. 3, including FIGS. 3A through 3H, shows a sensitive information redactor design with a small frame 11. The frame is configured to be of sufficient size to prevent tearing of the label when the tear-away device is pulled, thereby removing the label. The application and removal process as shown in FIGS. 3B through 3G is the same as in FIG. 1. The design shown in FIG. 3 is preferred for use on a container or other end-product surface in which the label is likely to release as a whole. It is preferred that the label not be applied to the container with a permanent adhesive, which would interfere with removal of the label, frame, and tear-away device from the container.

FIG. 4, including FIGS. 4A through 4J, shows a sensitive information redactor design with a small continuous frame with continuous adhesive on the back side 13. The frame is configured to be of sufficient size to prevent tearing of the label when the tear-away device is pulled, thereby removing the label. The application and removal process as shown in FIGS. 4B through 4I is the same as shown in FIG. 2. As in the design shown in FIG. 3, the design shown in FIG. 4 is preferred for use on a container or other end-product surface in which the label is likely to release as a whole. It is preferred that the label not be applied to the container with a permanent adhesive, which would interfere with removal of the label, frame, and tear-away device from the container.

FIG. 5, including FIGS. 5A through 5G, shows a sensitive information redactor consolidated with a label forming a consolidated sensitive information redactor label product 15. The tear-away device and label may be a single piece. The product may also include reinforcement at the juncture of the label and tear-away device, equivalent to where the frame would have been placed according to other embodiments. Although the tear-away device shown in this and other embodiments is a tab, it could take other forms.

FIG. 6, including FIGS. 6A through 6I, shows a consolidated sensitive information redactor label product as in FIG. 5 but having adhesive on the back side of the tear-away device. The adhesive on the back of the tear-away device may be the same or different from that of the frame of the label. Those skilled in the art will have knowledge of adhesives currently in use in the healthcare labeling industry and that will effectuate the desired results of the embodiments of the invention discussed herein.

FIG. 7, including FIGS. 7A through 7H, shows a two-ply (or two-layer) sensitive information redactor product. The two-ply design consists of a bottom-ply 17 and a top-ply 19 having a tear-away device. The application and removal process is the same as with FIG. 1 but in the two-ply design of FIG. 7 the bottom-ply stays on the container during removal allowing for a cleaner removal of a label from objects made from certain materials as it may be a primary interest to retain the adhesive properties of the label and/or condition of the object. For example, a prescription may be provided on a cardboard box making the two-ply design a particularly effective solution for easily removing sensitive information while maintaining the integrity of the label and container. Of course, none of the components of this embodiment should be constructed in a way that compromises the strength of the adhesion, which could result in an undesirable lack of adhesion and loss of the sensitive information redactor.

FIG. 8, including FIGS. 8A through 8G, shows a two-ply consolidated sensitive information redactor label product. The consolidated two-ply design consists of a bottom-ply 17 that remains affixed on the object and a removable consolidated sensitive information redactor label top-ply having an incorporated tear-away device 20. Similar to the bottom-ply shown in FIG. 7A the bottom-ply in FIG. 8A comprises one side of adhesive for affixing to an object. Affixed to the bottom-ply is the label with a tear-away device. As in the design of FIG. 7, the bottom ply enables the sensitive information to be easily removed as shown in FIGS. 8D through 8F, leaving the bottom-ply on the object. Of course, none of the components of this embodiment should be constructed in a way that compromises the strength of the adhesion, which could result in an undesirable lack of adhesion and loss of the sensitive information redactor.

FIG. 9, including FIGS. 9A through 9H, shows a sensitive information redactor design similar to the construction of that shown in FIG. 1, but having a tear-away device 21 that has a height equal to or approximately equal to that of the label to which they is applied. Application of the sensitive information redactor is shown in FIGS. 9B and 9C, and removal is shown in FIGS. 9E through 9G. The larger tear-away device provided in this embodiment makes the tear-away device easier to grasp and the sensitive information redactor easier to remove. This embodiment may also reduce the propensity of a label to tear upon removal.

FIG. 10, including FIGS. 10A through 10H, shows a sensitive information redactor design with a small continuous frame with the back comprising of part adhesive for affixing to an object and area without adhesive for use as the tear-away device. The frame has a height equal to or approximately equal to that of the label to which it is applied. Application of the sensitive information redactor is shown in FIGS. 10B and 10C, and removal is shown in FIGS. 10E through 10G. The larger tear-away device provided in this embodiment makes the tear-away device easier to grasp and the sensitive information redactor easier to remove while the continuous frame considers symmetry for efficiency of manufacture. This embodiment may also reduce the label's propensity to tear upon removal. As an alternative design to FIG. 10, the tear-away device may contain adhesive similar to FIG. 4.

FIG. 11, including FIGS. 11A through 11G, shows a consolidated sensitive information redactor label product 23 with the tear-away device contained within the construct of the new label frame. The label and sensitive information redactor product should be constructed in a way that does not compromise the strength of the resulting product, thereby reducing the ability to remove it.

The adhesive used in this embodiment should extend only across part of the label, allowing the tear-away device area 25 to be easily removed as necessary. In an alternative design, an adhesive is added along the entire top of product 23. In a further embodiment, the tear-away device area 25 is folded back upon the product 23 to produce a graspable tear-away device. In one embodiment (not shown), the tear-away device is a different color than the rest of the sensitive information redactor.

FIG. 12, including FIGS. 12A through 12G, shows a consolidated sensitive information redactor label product 27 with a two-ply tear-away device with the top-ply contained within the construct of the new label frame and the bottom-ply conjoined with the new label frame. The added ply to the tear-away device enables more effective isolation of the interplay between the tear-away device and the label. The application of FIG. 12 is shown in FIG. 12B, and removal is shown in FIGS. 12D through 12F.

Particular attention should be given to FIG. 12D where the bottom-ply of the tear-away device is separated from the new label frame 27 to form the tear-away device. Further attention should be given to FIG. 12E where it is shown that the bottom-ply remains on the container while the new label frame continues to be removed. Upon removal the bottom-ply 29 of the tear-away device of this design will remain on the container. The design of FIG. 12 should be constructed in a way that does not compromise the strength of the resulting product, thereby reducing the ability to remove it. The design shown in FIG. 12 is preferred for use on a container or other end-product surface in which the label is likely to release as a whole. It is preferred that the label not be applied to the container with a permanent adhesive, which would interfere with removal of the label, frame, and tear-away device from the container.

FIG. 13, including FIGS. 13A through 13H, shows a sensitive information redactor design with a large frame. This embodiment reduces the precision necessary when applying the frame to the label along with the material required for production. The sensitive information redactor shown in FIG. 13 differs from that shown in FIG. 1 due to the shape of the frame 31, which is a trapezoid rather than a parallelogram. Application of the sensitive information redactor as shown in FIGS. 13B and 13C is the same as that shown in FIG. 1. Removal as shown in FIGS. 13E through 13G also proceeds in the same fashion. Those skilled in the art will recognize that the sensitive information redactor as shown in FIG. 13 could also be assembled, applied, and removed as shown in FIG. 1.

FIG. 14, including FIGS. 14A through 14H, shows a sensitive information redactor design with a small frame. This embodiment reduces the precision necessary when applying the frame to the label and demonstrates that by varying the small frame adhesive may not be needed on the sensitive information redactor as areas of the adhesive on the label provide the adhesive for affixing to the object. The sensitive information redactor shown in FIG. 14 differs from that shown in FIG. 10 due to the shape of the frame 33, which is a trapezoid rather than a parallelogram. Application of the sensitive information redactor as shown in FIGS. 14B through 14C is the same as that shown in FIG. 10. Removal as shown in FIGS. 14E through 14G also proceeds in the same fashion. Those skilled in the art will recognize that the sensitive information redactor as shown in FIG. 14 could also be assembled, applied, and removed as shown in FIG. 10.

FIG. 15, including FIGS. 15A through 15I, shows a sensitive information redactor design with a frame 33 in the shape of an inverted, non-symmetric “V” extending the length of the sensitive information. This embodiment reduces the precision necessary when applying the frame to the label along with the material required for production. The location of the tear-away device at the end of the blade of the frame provides stability and strength in removal while the shaft portion of the frame enables the sensitive information redactor to remove a large area of sensitive information, as shown in FIG. 15 the whole label.

Application of the sensitive information redactor is shown in FIGS. 15B and 15D. Removal as shown in FIGS. 15F through 15G also proceeds in the same fashion as in FIG. 1. Those skilled in the art will recognize the optimal shape and tear-away device location that best effectuates the desire result for removing the sensitive information and label. The design in FIG. 15 can be easily inverted if the desired starting point for removal is at the bottom rather than the top.

FIG. 16, including FIGS. 16A through 16H, shows a sensitive information redactor design with a frame 35 that extends the length of the sensitive information. This enables the removal from the sensitive information from a label that is contained within a defined area of the label while leaving information on the bottom of the label. This could have a variety of uses. For example, information could be duplicated on the top and bottom of the label, allowing a user to retain information in a record book. Sensitive identifying information could be in the removable portion of the label, while non-identifying information (for example, a warning) could be on the bottom. Application and removal of the sensitive information redactor are shown in FIGS. 16B through 16C and in FIGS. 16E through 16G, respectively. The removed sensitive information redactor and remaining label portion are shown in FIG. 16H.

FIG. 17, including FIGS. 17A through 17G, shows a consolidated sensitive information redactor label product comprising perforated edges 37 around a defined area that will include sensitive information. As in the embodiment shown in FIG. 16, a portion of the label may remain.

FIG. 18, including FIGS. 18A through 18G, shows a consolidated sensitive information redactor label product comprising perforated edges 39 around a large area to enable broad redaction of information. These perforations allow all or part of the label to be removed by pulling the tear-away device, leaving a base label and a selected portion of the upper label outside the perforations. It is important for this embodiment that the adhesive retaining the base label to the object be sufficiently strong that the base label is not removed when a user attempts to tear the item at the perforations.

FIG. 19, including FIGS. 19A through 19H, shows a sensitive information redactor design with a large frame 41 with designated open areas within the frame 43 (in this case three). The design of FIG. 19 considers that only a certain area within the construct of the large frame is required to effectuate the removal of sensitive information and/or a label. The application and removal is the same as in FIG. 1. Since the areas designated by 41 may be open to start as shown in FIG. 19B, upon removing the sensitive information redactor the open areas may be filled by the label in which it was conjoined as is shown in FIG. 19F. The size and number of open areas can be augmented to effectuate a desired result.

FIG. 20, including FIGS. 20A through 20G, shows a consolidated sensitive information redactor label product with a tear-away device containing reinforced material in designated areas 45 for removal or shredding of sensitive information. The application of FIG. 20 is shown in FIG. 20B, and removal is shown in FIGS. 20D through 20F. Particular attention should be given to FIG. 20E, wherein the tear-away device is being removed capturing at least the areas reinforced by additional material. Further attention should be given to FIG. 20G where it is shown that the some of the surface area of the label remains on the container but absent of legible sensitive information. Those skilled in the art will recognize the optimal material and tear-away device location that best effectuates the desired result for removing sensitive information. The size and number places of reinforcement can be easily augmented to effectuate a desired result.

FIG. 21, including FIGS. 21A through 21I, shows a one-ply sensitive information redactor with a large frame, a tear away device 47 and a tear-away device release mechanism 49. The tear-away device and tear-away device release mechanism are initially adjoined by a perforated edge. The tear-away device release mechanism extends beyond the height of the frame and contains adhesive for initial affixment to the container. Upon completion of application as shown in FIGS. 21B through 21C both the tear-away device and tear-away device release mechanism are covered by the label.

The design shown in FIG. 21 deters inadvertent removal of the label and the information redactor by requiring a two-step removal process. Application for FIG. 21 is the same as in FIG. 1. Removal requires engagement of two tear-away devices adjoined by a perforated edge as shown in FIGS. 21E through 21H. The first step of removal shown in FIG. 21E requires the user to pull the tear-away release mechanism along the perforated edge whereby exposing the sensitive information tear-away device as shown in FIG. 21F. The second step as shown in FIG. 21F requires the engagement of and force applied to the newly exposed tear-away device to withdraw the sensitive information from the container. FIG. 21I shows the removed tear-away device release mechanism and the removed label conjoined with the sensitive information redactor. This process prevents accidental removal of the label, and maintains the integrity of the label until a user wishes to remove it. If the integrity of the label is better maintained, the label once removed is more easily and effectively placed in a personal or official medical log.

FIG. 22, including FIGS. 22A through 22G, shows a sensitive information redactor with an extra large single-ply frame with a two-ply tear-away device comprising a top-ply tear away device and a bottom-ply tear-away device release mechanism. The two-ply tear-away device comprises of a tear-away device release mechanism having adhesive and a perforated edge 51 and tear-away device 53. The tear-away release mechanism and tear-away device are designed to extend beyond the label and be partially affixed to the container upon application. As with FIG. 21 this design deters inadvertent removal of the label and the by requiring a two-step removal process while providing easier access to the tear-away devices than in FIG. 21.

Application for the embodiment of FIG. 22, as shown in FIGS. 22B through 22D begins with affixing the frame to a container leaving the tear-away release mechanism and tear-away device unaffixed, to avoid the label being applied overtop during application as shown in FIG. 22C and 22D. After the label has been affixed to the container the tear-away release mechanism and tear-away device are affixed to the container and/or label opposite the starting point, creating the final product as shown in 22E. Removal is similar to that of FIG. 21, requiring engagement of the two tear-away devices initially adjoined by a perforated edge as shown in FIGS. 22F through 22G.

The first step of removal shown in FIG. 22F requires the user to pull the tear-away release mechanism along a perforated edge, exposing the sensitive information tear-away device as shown in FIG. 22G. The second step as shown in FIG. 22G requires engagement and force to the newly exposed tear-away device to withdraw the sensitive information from the container. FIG. 22G shows the removed tear-away device release mechanism and the removed label conjoined with the sensitive information redactor. This process prevents accidental removal of the label, and maintains the integrity of the label until a user wishes to remove the label. If the integrity of the label is better maintained, it is more easily and effectively placed in a personal or official medical log.

FIG. 23, including FIGS. 23A through 23J, shows a sensitive information redactor with a medium frame having an adjoined tear-away device. The medium frame is comprised of one side of adhesive for affixing to an object and the other side for conjoining with a label. The tear-away device is two-ply consisting of a bottom ply 55 that has adhesive for affixing to the object along with the frame and a top-ply 57 that is conjoined together with the bottom ply by a perforated edge. The tear-away device contains a tear-away device release mechanism 59 that upon removal is engaged separate from the perforated edges and two-ply tear-away device. The application of this design is the same as in FIG. 22.

Removal is shown in FIGS. 23F through 23I. Removal begins with engaging the tear-away device release mechanism to break the perforated edge, releasing the tear-away device bottom-ply from the top-ply and frame of the sensitive information redactor as shown in FIG. 22G. The tear-away device is now able to be employed to remove the label and/or sensitive information as shown in 23H. It should be noted that due to the tear-away device extending beyond the label, a portion of the bottom-ply may remain on the label but ultimately removed in the continuous removal process as shown with 23J.

As with FIG. 21 and FIG. 22 this design deters inadvertent removal of the label by requiring a two-step removal process. In addition, it should be noted again that this design may be augmented to optimize performance and desired traits including, but not limited to, the size and shape of frame, places and types of adhesives used, size and shape of tear-away devices, color and transparency, component locations and construction materials.

FIG. 24 shows an embodiment of the invention incorporated into a printable page. Such a page is popular in retail pharmacies. This could be printed as a single page or as multiple pages as in a sheet of labels. It could also be printed in a roll, with perforations at the top and bottom, allowing use in a mass-production environment.

FIGS. 25 through 27 show embodiments of the invention used on objects other than prescription bottles and vials. For example, FIG. 25 shows a newspaper, FIG. 26 a magazine, and FIG. 27 a purchased vase. Such embodiments allow an individual to remove information before recycling, discarding, or displaying the item upon which the label is placed.

Patents, patent applications, publications, scientific articles, books, web sites, and other documents and materials referenced or mentioned herein are indicative of the levels of skill of those skilled in the art to which the inventions pertain, as of the date each publication was written, and all are incorporated by reference as if fully rewritten herein. Inclusion of a document in this specification is not an admission that the document represents prior invention or is prior art for any purpose.

I claim:

1. A sensitive information redactor comprising:
a frame, said frame comprising means for removing at least part of said frame and at least part of a label.

2. The sensitive information redactor of claim 1, wherein said frame comprises adhesive.

3. The sensitive information redactor of claim 1, wherein at least part of said frame protrudes from beneath the underside of said label.

4. The sensitive information redactor of claim 1, wherein said means for removing is a tab.

5. The sensitive information redactor of claim 1, wherein said means for removing has an adjoining release mechanism comprising a means for releasing said means for removing at least part of said frame and at least part of said label.

6. The sensitive information redactor of claim 5, wherein said release mechanism comprises adhesive.

7. The sensitive information redactor of claim 5, wherein said release mechanism comprises perforations.

8. The sensitive information redactor of claim 1, wherein said label shows information, and said information includes at least one member of the group consisting of name, address, date of birth, account information, height, weight, eye color, hair color, picture, health information, prescription name, prescription type, Rx number, prescription instructions, prescription warnings, dose, quantity, refills, dates, prescribing doctor, business name, business address, business phone number, price, bar code, method of payment, and Social Security number.

9. The sensitive information redactor of claim 1, wherein said label comprises perforations and information, and wherein said frame and means for removing are adapted to permit at least part of said information to be redacted.

10. The sensitive information redactor of claim 1, wherein said frame is reinforced by at least one material selected from the group consisting of fiberglass, plastic, metal, and cotton fiber.

11. A system for redacting sensitive information, comprising:
(a) providing an object with a sensitive information redactor of claim 1, said sensitive information redactor comprising sensitive information;
(b) determining that said sensitive information should be separated from said object;
(c) redacting said sensitive information.

12. A sensitive information redactor comprising an adhesive ply for affixing to an object and a removable ply initially conjoined to said adhesive ply, said removable ply comprising a frame, said frame comprising means for removing at least part of said frame and at least part of a label.

13. The sensitive information redactor of claim 12, wherein said means for removing has an adjoining release mechanism comprising a means for releasing said means for removing at least part of said frame and at least part of said label.

14. The sensitive information redactor of claim 13, wherein said release mechanism comprises adhesive.

15. The sensitive information redactor of claim 13, wherein said release mechanism comprises perforations.

16. The sensitive information redactor of claim 12, wherein said label bears sensitive information and said sensitive information includes at least one member of the group consisting of name, address, date of birth, account information, height, weight, eye color, hair color, picture, health information, prescription name, prescription type, Rx number, prescription instructions, prescription warnings, dose, quantity, refills, dates, prescribing doctor, business name, business address, business phone number, price, bar code, method of payment, and Social Security number.

17. The sensitive information redactor of claim 12, wherein said means for removing is a tab.

18. The sensitive information redactor of claim 12, wherein said removable ply comprises perforations adapting the removable ply for detachment along the location of said perforations.

19. A system for redacting sensitive information, comprising:
(a) providing an object with a sensitive information redactor of claim 12, said sensitive information redactor comprising sensitive information;
(b) determining that said sensitive information should be separated from said object;
(c) redacting said sensitive information by removing said removable ply;
(d) safeguarding said sensitive information.

20. A removable label for sensitive information, said label comprising an adhesive side, a side for bearing information, and a means for removing said label, wherein said means for removing said label is integral to said label.

21. A health care prescription sheet comprising at least one label of claim 20.
